(19) United States
(12) Patent Application Publication
(10) Pub. No.: US 2008/0059811 A1
(43) Pub. Date: Mar. 6, 2008

(54) Tamper resistant networking

(76) Inventors: Ravi Sahita, Beaverton, OR (US); Ajay Garg, Portland, OR (US)

Correspondence Address: CAVEN & AGHEVLI;c/o INTELLEVATE, P.O. BOX 52050, MINNEAPOLIS, MN, 55402, US

(21) Appl. No.: 11/516,113

(22) Filed: Sep. 6, 2006

(51) Int. Cl. G06F 12/14

(52) U.S. Cl. 713/194

(57) ABSTRACT

Methods and apparatus to provide tamper resistant networking are described. In one embodiment, one or more instructions corresponding to a device driver are stored in a memory of a network security module that is coupled between a network adapter and a host computing device. In an embodiment, the network security module may have exclusive access to the network adapter to protect the host computing device from various security hazards. Other embodiments are also described.

### BACKGROUND

The present disclosure generally relates to the field of electronics. More particularly, an embodiment of the invention relates to techniques for provision of tamper resistant networking in a computing system.

Computer networks have become an integral part of computing. With the growth of computer networks, however, network-based worm and virus attacks have become a recurring fact of operating computer networks, especially for computer networks that are in communication with the Internet. Such attacks may present a significant risk to enterprises in terms of protection of intellectual property and business continuance.

In one instance, current implementations may provide some protection capabilities against such attacks via a host operation system, for example, in the form of applications or kernel drivers. In such cases, the protection capabilities may still be vulnerable to malicious, mal-configured, or faulty components which may actively intrude upon or circumvent the operating system functions. Also, such solutions may be disabled by a user (whether knowingly or inadvertently), thereby reducing security.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates various components of an embodiment of a networking environment, which may be utilized to implement various embodiments discussed herein.

FIGS. 2, 4, and 5 illustrate block diagrams of embodiments of computing systems, which may be utilized to implement various embodiments discussed herein.

FIG. 3 illustrates a flow diagram of a method to protect a host computing device from network-based security hazards, according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

Some of the embodiments discussed herein may provide tamper resistant networking. In one embodiment, one or more instructions corresponding to a device driver are stored in a memory of a network security module that is coupled between a network adapter and a host computing device. In one embodiment, the network security module may have exclusive access to the network adapter to protect the host computing device from various security hazards that may be present on the computer network coupled to the network adapter. Further, verified third-party network services may be provisioned for execution on the network security module. In some embodiments, the tamper resistant network services may continue to function even when the host device is compromised or attacked. Also, persistent communication via a computer network may be maintained even when the host device is compromised or attacked. Further, the persistent communication may be used to recover the host device after the host device is compromised.

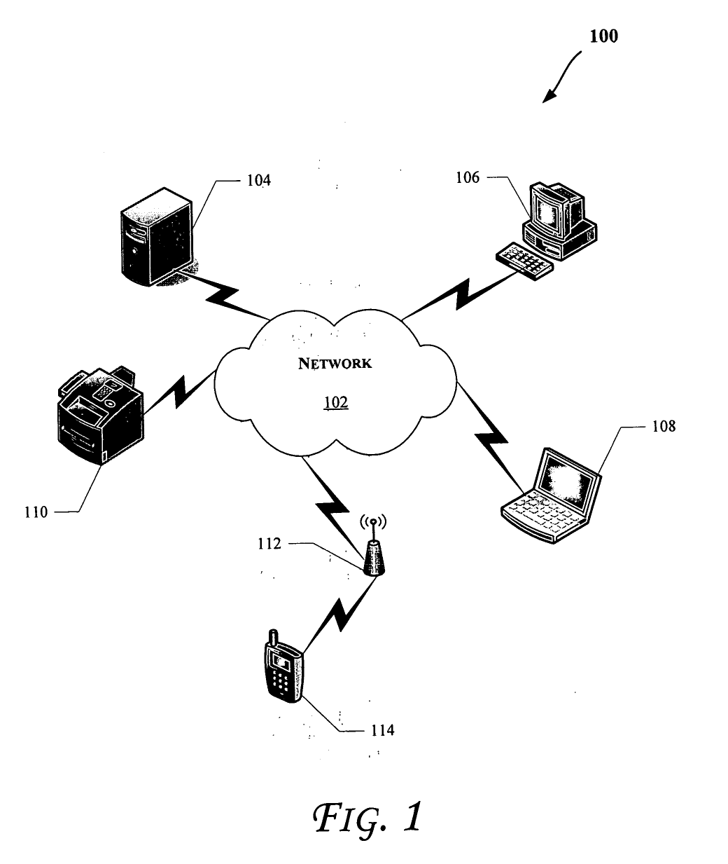

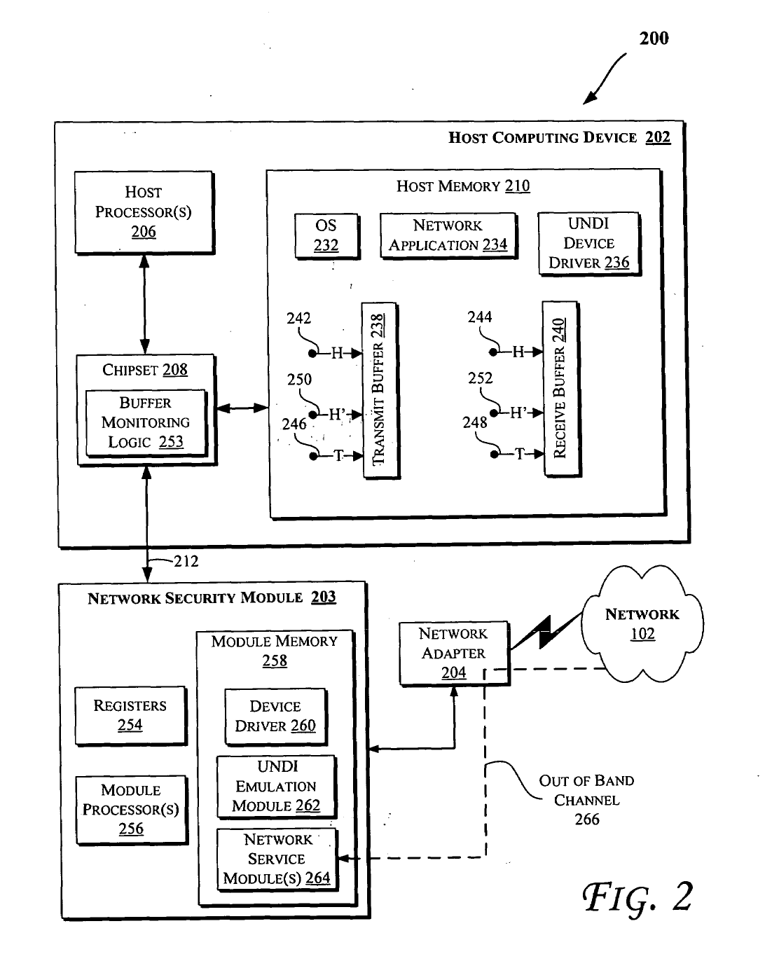

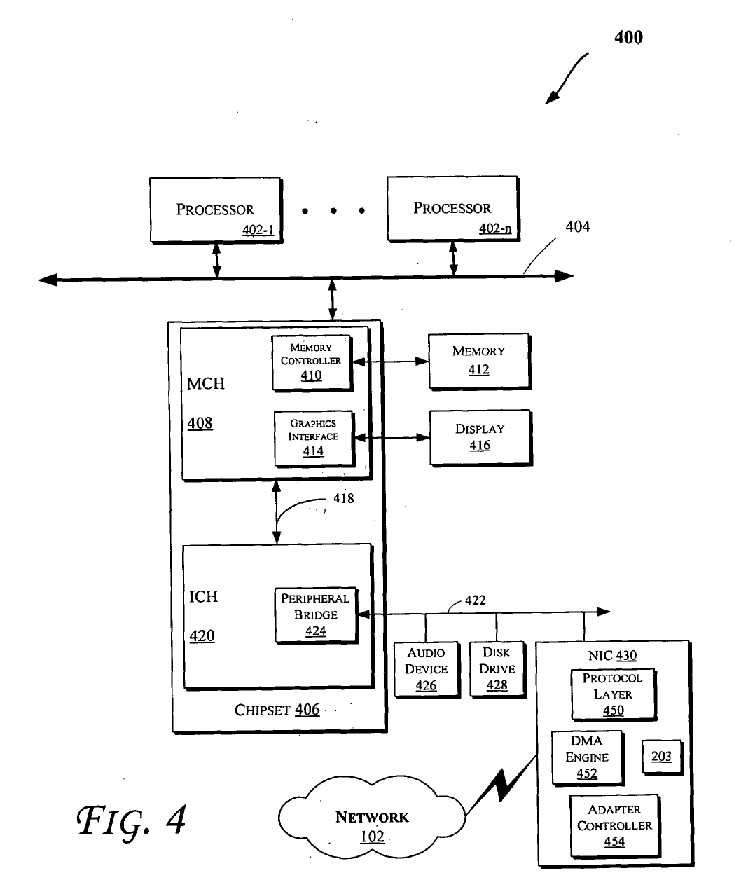

Additionally, some of the embodiments discussed herein may be applied in various environments, such as the networking environment discussed with reference to FIG. 1 and/or the computing systems discussed with reference to FIGS. 2, 4, and/or 5. More particularly, FIG. 1 illustrates various components of an embodiment of a networking environment 100, which may be utilized to implement various embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device,. etc.), a wireless access point 112, a personal digital assistant or smart phone 114, a rack-mounted computing system (not shown), etc. The network 102 may be any type of type of a computer network including an intranet, the Internet, and/or combinations thereof.

The devices 104-114 may communicate with the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) such as a network interface card (NIC) or external network interface devices (e.g., having a separate physical enclosure and/or power supply than the computing system to which it is coupled).

FIG. 2 illustrates a block diagram of an embodiment of a computing system 200. One or more of the devices 104-114 discussed with reference to FIG. 1 may comprise the computing system 200. The computing system 200 may include a host computing device 202, a network security module 203, and a network adapter 204. The host computing device 202 may communicate with various devices coupled to the network 102 via the network security module 203 and the network 204. In one embodiment, the network security module 203 may have exclusive access to the network adapter 204, e.g., to protect the host computing device 202 from various security hazards that may be present on the network 102.

As shown in FIG. 2, the device 202 may include one or more processors 206 (which may be collectively referred to herein as “processors 206” or “processor 206”). The processors 206 may be any type of processor such as those discussed with reference to FIG. 4. Moreover, the processors 206 may have a single or multiple core design. The processors 206 with a multiple core design may integrate different types of processor cores on the same integrated circuit (IC) die. Also, the processors 206 with a multiple core design may be implemented as symmetrical or asymmetrical multiprocessors.

The device 202 may additionally include a chipset 208 to couple the module 203 to one or more components of the host computing device 202 such as host memory 210. Alternatively, the processors 206 may include a memory controller to enable direct communication between the processors 206 and the host memory 210, rather than through the chipset 208. In an embodiment, the chipset 208 may communicate with the module 203 through a bus 212. Any suitable configuration may be utilized for the bus 212. For example, the bus 212 may comply with various types of peripheral component interconnect (PCI) standards, including PCI Local Bus Specification (Revision 3.0, Mar. 9, 2004), PCI-X Specification (Revision 2.0a, Apr. 23, 2003), and/or PCI Express (PCIe) Specifications (PCIe Specification, Revision 1.0a, June 2005). Alternatively, the bus 212 may comprise other types and configurations of interconnection networks.

In an embodiment, the host memory 210 may store one or more of the following: an operating system (OS) 232, network application 234, universal network device interface (UNDI) device driver 236, transmit buffer 238 (e.g., to store data that is to be transmitted via the network 102), and/or receive buffer 240 (e.g., to store data that is to received from the network 102). The application 234 may execute (e.g., on the processor(s) 206) to communicate one or more data packets with one or more computing devices coupled to the network 102 (such as the devices 104-114 of FIG. 1). In an embodiment, a packet may be a sequence of one or more symbols and/or values that may be encoded by one or more electrical signals transmitted from at least one sender to at least on receiver (e.g., over a network such as the network 102).

Additionally, the UNDI device driver 236 may provide a programming interface for network interface cards (e.g., that may include the module 203 and adapter 204 in an embodiment) that is used by a pre-boot execution environment protocol. Generally, the pre-boot execution environment (PXE, a.k.a. Pre-Execution Environment) may be an environment to bootstrap computers using a network interface card independently of available data storage devices (such as hard disks) or installed operating systems.

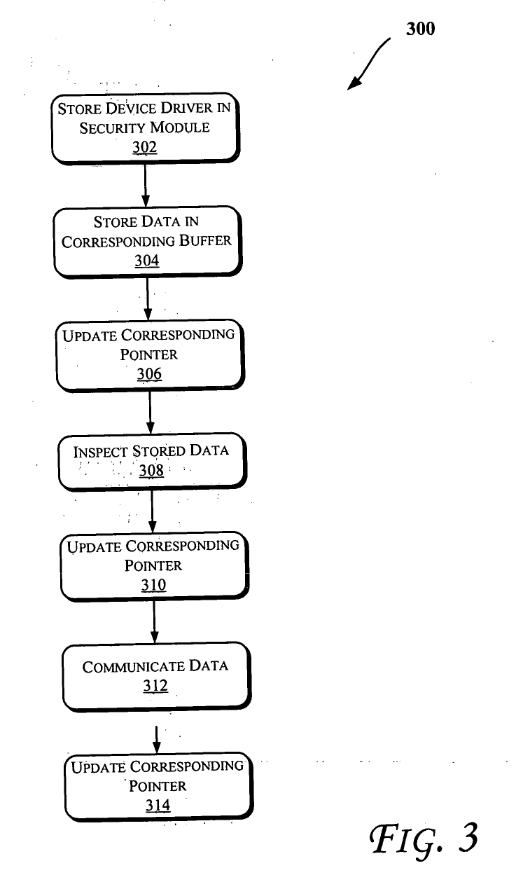

Furthermore, each of the buffers 238 and 240 may have a corresponding head pointer (e.g., 242; and 244, respectively), tail pointer (e.g., 246 and 248, respectively), and/or shadow head pointer (e.g., 250 and 252, respectively) as will be further discussed herein, e.g., with reference to FIG. 3. In one embodiment, the host computing device 202 may store the address of the pointers 242-252 in hardware registers (not shown) and/or locations within the memory 212. Moreover, in an embodiment, one or more of the buffers 238 and/or 240 may be implemented as circular ring buffers. A buffer monitoring logic 253 may monitor changes to the pointers 242-252 and generate signals to cause the network security module 203 and/or the host computing device 202 to perform various tasks, as will be further discussed herein, e.g., with reference to FIG. 3. Moreover, more than one buffer monitoring logic 253 may be used in some embodiments (for example, one for each of the buffers 238 and 240).

As shown in FIG. 2, the network security module 203 may include one or more registers 254, one or more module processors 256 (which may be collectively referred to herein as “processors 256” or “processor 256”), and/or a module memory 258. The registers 254 may store the address of one or more of the pointers 242-252. Alternatively, the address of one or more of the pointers 242-252 may be stored in the memory 258. As shown in FIG. 2, the processors 256 may be processors embedded in the module 203 in an embodiment. Alternatively, one or more of the processors 206 (or other logical partitioning of processors or processor cores) may be utilized to perform various tasks that are assigned to the processors 256 for execution. The memory 258 may include a device driver 260 (which may include network adapter 204 specific commands), a UNDI emulation module 262 (e.g., to emulate a receiving module for the UNDI device driver 236 such that the network security module 203 appears as a network adapter to the host computing device 202), and/or one or more secure service modules 264.

In an embodiment, the application 234 may utilize the OS 232 to communicate with devices coupled to the network 102, e.g., through the device drivers 236, 262, and 260. Hence, the device driver 236 may include universal network adapter specific commands to provide a communication interface between the OS 232 and a network adapter (e.g., via the network security module 203 in an embodiment). In one embodiment, the network security module 203 may appear as a network adapter to the host computing device 202 by utilizing the UNDI emulation module 262, which may be in communication with the UNDI device driver 236. Hence, the adapter 204 may not be visible to the host device 202. For example, in embodiments where the bus 212 is a PCI bus, a non-transparent PCI-PCI bridge may be provided in the network security module 203.

In an embodiment, the device driver 236 may allocate one or more entries in the buffer 238 to store packet data for transmission over the network 102 (e.g., via the module 203 and the adapter 204). Also, the network adapter 204 (e.g., via a direct memory access (DMA) module, provided in the network adapter 204 in an embodiment) may allocate one or more entries in the buffer 240 through the module 203 to store packet data received from the network 102. As new entries are stored in or read from the buffers 238 and 240, their corresponding pointers are updated. In turn, the logic 253 may signal one or more components of the system 200, as will be discussed herein, e.g., with reference to FIG. 3.

Furthermore, in an embodiment, the OS 232 may include a protocol stack (not shown) which may include a set of procedures or programs that when executed process packets communicated over a network (102) and stored in buffers 238 and/or 240. For example, TCP/IP (Transport Control Protocol/Internet Protocol) packets may be processed using a TCP/IP stack. Also, the memory 258 may store one or more network service modules 264, such as modules for an operation system update, virus detection, worm detection, antivirus tool, anti-worm tool, network intrusion prevention, or a firewall. The modules 264 may include third-party network services (which may be verified prior to storage in the memory 258 in one embodiment). Also, a virtual machine (VM) based framework may be utilized by the system 200 to allow for services (e.g., provided through the modules 264) to be able to provide value add, differentiation to the platform, etc., while the VM framework may limit interference of one or more modules (e.g., one or more of the modules 264) with the operation of other modules (e.g., one or more of the modules 264) executing on the system 200. In an embodiment, an out of band (OOB) channel 266 may be used to store data corresponding to the modules 264 that may be transferred over the network 102. Moreover, the channel 266 may be a secure channel, e.g., provided by encrypting the data transmitted over the OOB channel 266. In one embodiment, the OOB channel 266 may be a virtual private network (VPN) channel.

FIG. 3 illustrates a flow diagram of a method 300 to protect a host computing device from network-based security hazards, according to an embodiment. In an embodiment, various components discussed with reference to FIGS. 1, 2, 4, and/or 5 may be utilized to perform one or more of the operations discussed with reference to FIG. 3. For example, some of the operations of FIG. 3 may protect the host computing device 202 of FIG. 2 from security hazards present on the computer network 102.

Referring to FIGS. 1-3, at an operation 302, a device driver (e.g., device driver 260) may be stored in a security module memory (e.g., the memory 258). At an operation 304, data to be transmitted or received data may be stored in a corresponding buffer (e.g., in buffers 238 and 240, respectively). At an operation 306, the corresponding pointer to the data stored at operation 304 may be updated. For example, in case of data received from the network 102, the network adapter 204 (via a DMA engine, for example) may add entries in the receive buffer 240 between pointers 252 (H′) and 248 (T) (e.g., as, long as pointer 252 is not pointing to the same entry as pointer 248). In case of transmitting data from the host computing device 202 over the network 102, the UNDI device driver 236 may add entries in the transmit buffer 238 between pointers 242 (H) and 246 (T) (e.g., as long as pointer 242 is not pointing to the same entry as pointer 246). At an operation 306, the corresponding pointer may be updated. For example, at operation 306, in case of receiving data, pointer 252 (H′) may be moved upon adding an entry to the buffer 240 at operation 304. Further, at operation 306, in case of transmitting data, pointer 246 (T) may be moved upon adding an entry to the buffer 238 at operation 304. [0026] At an operation 308, the stored data of operation 304 may be inspected. For example, the buffer monitoring logic 253 may generate a signal in response to the updating at operation 306 to indicate the occurrence of a change to the stored data to one or more of the host computing device or the network security module. For example, in case of receiving data, the logic 253 may signal the network security module 203 to inspect the entries between 252 (H′) and 248 (T). Further, in case of transmitting data, the logic 253 may signal the network security module 203 to inspect the entries between 242 (H) and 246 (T). At an operation 310, the corresponding pointer may be updated after the stored data is inspected. For example, at operation 310, in case of receiving data, pointer 244 (H) may be moved upon inspecting of an entry of the buffer 240 at operation 308. Further, at operation 310, in case of transmitting data, pointer 250 (H′) may be moved upon inspecting an entry of the buffer 238 at operation 308.

At an operation 310, the data stored (at operation 304) and inspected (at operation 308) may be communicated. For example, in case of receiving data, once the pointer 244 (H) is updated at operation 310, the logic 253 may generate a signal (e.g., an interrupt signal) to the driver-236 to indicate that data is received and the driver 236 may read the data from the receive buffer 240 between pointers 244 (H) and 248 (T) (e.g., until the tail pointer 248 (T) is smaller than the head pointer 244 (H)). Further, in case of transmitting data, once the pointer 250 (H′) is updated at operation 310, the logic 253 may generate a signal to the network adapter 204 to cause transmission of the data stored between pointer 242 (H) and 250 (H′) (e.g., as long as the head pointer 242 (H) is smaller than the shadow pointer 250 (H′) and the shadow pointer 250 (H′) is smaller than or equal to the tail pointer 246 (T)). At an operation 312, the corresponding pointer may be updated after the stored data is communicated. For example, at operation 312, in case of receiving data, the tail pointer 248 (T) may be updated to point to the same entry as the head pointer 244 (H). Further, at operation 312, in case of transmitting data, the head pointer 242 (H) may be updated to point to the same entry as the shadow head pointer 250 (H′).

FIG. 4 illustrates a block diagram of a computing system 400 in accordance with an embodiment of the invention. The computing system 400 may include one or more central processing unit(s) (CPUs) 402 or processors that communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 206 and/or 256 of FIG. 2. Also, the operations discussed with reference to FIGS. 1-3 may be performed by one or more components of the system 400.

A chipset 406 may also communicate with the interconnection network 404. The chipset 406 may include a memory control hub (MCH) 408. The MCH 408 may include a memory controller 410 that communicates with the memory 412 (which may be the same or similar to the memory 210 of FIG. 2). The memory 412 may store data, including sequences of instructions, which may be executed by the CPU 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The MCH 408 may also include a graphics interface 414 that communicates with a display device 416. In one embodiment of the invention, the graphics interface 414 may communicate with the display device 416 via an accelerated graphics port (AGP). In an embodiment of the invention, the display 416 (such as a flat panel display) may communicate with the graphics interface 414 through, for example, a signal converter that translates a digital representation of an image stored in a storage device such as video memory or system memory into display signals that are interpreted and displayed by the display 416. The display signals produced by the display device may pass through various control devices before being interpreted by and subsequently displayed on the display 416.

A hub interface 418 may allow the MCH 408 and an input/output control hub (ICH) 420 to communicate. The ICH 420 may provide an interface to I/O device(s) that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device or network interface card (NIC) 430 (which is in communication with the computer network 403). Other devices may communicate via the bus 422. Also, various components (such as the network interface device 430) may communicate with the MCH 408 in some embodiments of the invention. In addition, the processor 402 and the MCH 408 may be combined to form a single chip. Furthermore, a graphics accelerator may be included within the MCH 408 in other embodiments of the invention.

As illustrated in FIG. 4, the NIC 430 may include a (network) protocol layer 450 for implementing the physical communication layer to send and receive network packets to and from remote devices over the network 102. The network 102 may include any type of computer network such as those discussed with reference to FIG. 1. The NIC 430 may further include a direct memory access (DMA) engine 452, which writes packets to data buffers (e.g., buffers 238 and/or 240 of FIG. 2) to transmit and/or receive data over the network 102. Additionally, the NIC 430 may include a network adapter controller 454, which may include logic (such as a programmable processor) to perform adapter related operations. In an embodiment, the adapter controller 454 may be a MAC (media access control) component. The NIC 430 may further include a memory (not shown), such as any type of volatile/nonvolatile memory (e.g., including one or more cache(s) and/or other memory types discussed with reference to memory 412). Additionally, the NIC 430 may include the network security module 203 in an embodiment.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

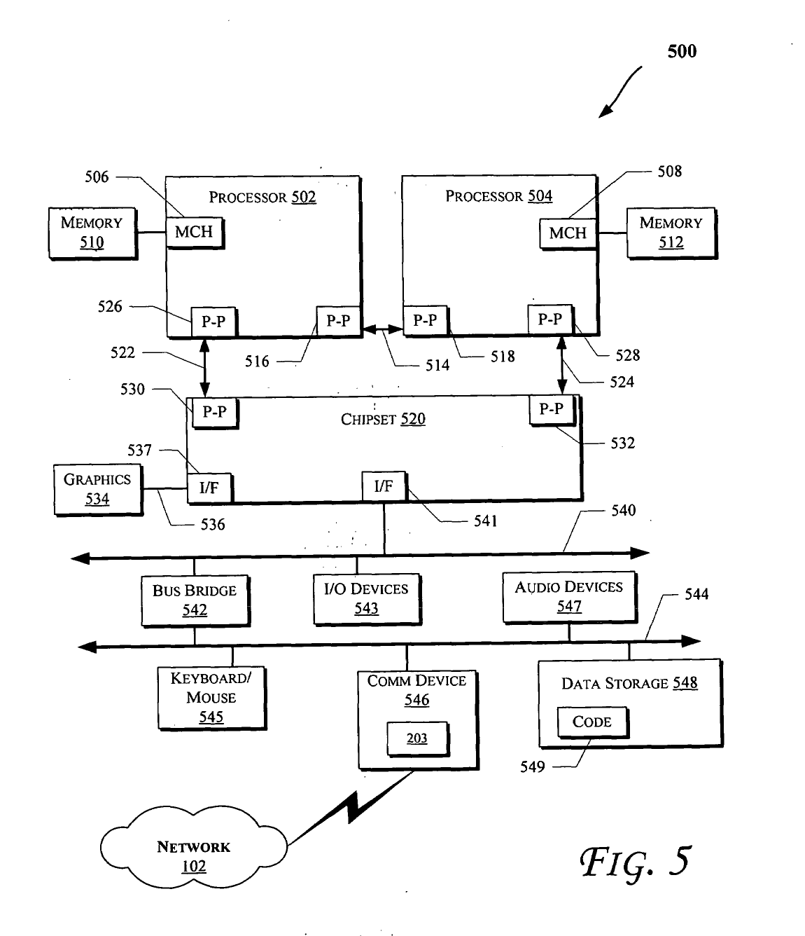

FIG. 5 illustrates a computing system 500 that is arranged in a point-to-point (PtP) configuration, according to an embodiment of the invention. In particular, FIG. 5 shows a system, where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 412 of FIG. 4 and/or the memory 210 of FIG. 2.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a graphics circuit 534 via a graphics interface 536, e.g., using a PtP interface circuit 537.

The chipset 520 may communicate with a bus 540 using a PtP interface circuit 541. The bus 540 may communicate with one or more devices, such as a bus bridge 542 and 1/O devices 543. Via a bus 544, the bus bridge 542 may communicate with other devices such as a keyboard/mouse 545, communication devices 546 (such as modems, network interface devices, or other communication devices that may communicate with the computer network 403), audio I/O device 547, and/or a data storage device 548. The data storage device 548 may store code 549 that may be executed by the processors 502 and/or 504.

At least one embodiment of the invention may be provided within the communication device 546. For example, the network security module 203 of FIG. 2 may be located within the communication device 546. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment,” “an embodiment,” or “some embodiments” means that a particular feature, structure, or characteristic described in connection with the embodiment(s) may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A network security apparatus comprising:
a memory to store one or more instructions corresponding to a device driver, the device driver to facilitate communication with a computer network via a network adapter; and
a processor to execute the one or more instructions to communicate data between the computer network and a host computing device.

2. The apparatus of claim 1, further comprising a network interface card that comprises the processor and the network adapter.

3. The apparatus of claim 2, wherein the network interface card further comprises the memory.

4. The apparatus of claim 2, further comprising a chipset to couple the network interface card to one or more components of the host computing device.

5. The apparatus of claim 1, wherein the host computing device comprises a host memory to store data that is communicated between the computer network and the host computing device.

6. The apparatus of claim 5, wherein the host memory comprises one or more circular buffers to store the data.

7. The apparatus of claim 1, wherein the memory further stores a universal network device interface emulation module and the host computing device comprises a host memory to store a universal network device interface to facilitate communication between the universal network device interface emulation module and the host computing device.

8. The apparatus of claim 1, wherein the memory further stores one or more instructions corresponding to one or more network services.

9. The apparatus of claim 8, wherein the one or more network services comprise one or more of: an operation system update, virus detection, worm detection, antivirus tool, anti-worm tool, network intrusion prevention, or a firewall.

10. A method comprising:
storing one or more instructions corresponding to a device driver in a memory of a network security module, the device driver to facilitate communication with a computer network via a network adapter; and
executing the one or more instructions to communicate data between the computer network and a host computing device.

11. The method of claim 10, further comprising inspecting data to be communicated between the computer network and the host computing device.

12. The method of claim 10, further comprising storing data that is communicated between the computer network and the host computing device in a memory of the host computing device.

13. The method of claim 12, further comprising updating a pointer to a location in the host computing device memory corresponding to the stored data.

14. The method of claim 13, further comprising generating a signal in response to the updating to indicate an occurrence of a change to the stored data to one or more of the host computing device or the network security module.

15. The method of claim 12, further comprising storing the data in one or more circular buffers.

16. The method of claim 10, further comprising communicating data between the host computing device and the network adapter via the network security module.

17. The method of claim 10, further comprising:
storing a universal network device interface emulation module in the memory; and
storing a universal network device interface in a memory of the host computing system to facilitate communication between the universal network device interface emulation module and the host computing device.

18. The method of claim 10, further comprising storing one or more instructions corresponding to one or more network services in the memory.

19. The method of claim 18, wherein the one or more network services comprise one or more of: an operation system update, virus detection, worm detection, antivirus tool, anti-worm tool, network intrusion prevention, or a firewall.

20. A computer-readable medium comprising one or more instructions that when executed on a processor configure the processor to:
store one or more instructions corresponding to a device driver in a memory of a network security module, the device driver to facilitate communication with a computer network via a network adapter; and
execute the one or more instructions to communicate data between the computer network and the host computing device.

21. The computer-readable medium of claim 20, further comprising one or more instructions that configure the processor to store data that is communicated between the computer network and the host computing device in a memory of the host computing device.

22. The computer-readable medium of claim 20, further comprising one or more instructions that configure the processor to communicate data between the host computing device and the network adapter via the network security module.

23. A computing system comprising:
a display device; and
a network security module coupled to the display device and comprising a memory to store a device driver to facilitate communication between the network security module and a computer network via a network adapter, the network security module to couple between the network adapter and a host computing device to provide one or more network services.

24. The system of claim 23, wherein the display device comprises a flat panel display.

25. The system of claim 23, wherein the host computing device comprises a host memory to store data that is communicated between the computer network and the host computing device.

26. The system of claim 23, wherein the memory further stores a universal network device interface emulation module and the host computing device comprises a host memory to store a universal network device interface to facilitate communication between the universal network device interface emulation module and the host computing device.
